(19) United States
(12) Patent Application Publication
(10) Pub. No.: US 2024/0028395 A1
(43) Pub. Date: Jan. 25, 2024

(54) MANAGING AN OPERATION OF A DATA CENTER BASED ON PREDICTING LOCALIZED WEATHER CONDITIONS

(71) Applicant: International Business Machines Corporation, Armonk, NY (US)

(72) Inventors: Anthony P. PRAINO, Poughquag, NY (US); Eli Michael DOW, Pleasant Valley, NY (US); Lloyd A. TREINISH, Cortlandt Manor, NY (US)

(21) Appl. No.: 17/813,928

(22) Filed: Jul. 20, 2022

(51) Int. Cl. G06F 9/48; G01W 1/10

(52) U.S. Cl. CPC G06F 9/4887; G01W 1/10

(57) ABSTRACT

A data center management system may predict localized weather conditions for a location of a data center during a period of time. The data center management system may determine whether the localized weather conditions will degrade an operation of the data center during the period of time. The data center management system may obtain computational workload information identifying one or more computational workloads scheduled for execution at the data center during the period of time. The data center management system may determine, based on the computational workload information, one or more priorities associated with the one or more computational workloads. The data center management system may schedule the one or more computational workloads for execution based on the one or more priorities and based on determining whether the localized weather conditions will degrade the operation of the data center.

### BACKGROUND

The present invention relates to managing an operation of a data center, and more specifically, to managing the operation of the data center using highly localized predictions of weather conditions tailored for site of the data center.

Weather conditions can be predicted for a geographical area. Typically, the weather conditions are predicted for a large geographical area, such as a geographical area covered by a state, county, city or five-digit zip code. In some situations, the predicted weather conditions may be used to predict the amount of electricity that can be produced by a power plant that provides energy to operate a data center. For example, the predicted weather conditions may be used to predict an amount of power that will be output by a power plant that utilizes renewable energy resources to generate electrical power.

In some situations, because the geographical area is large, the predicted weather conditions may not be sufficiently specific with respect to the location of the data center. For example, actual weather conditions at a location of the data center may be different than those predicted for a large geographical area. Therefore, the predicted weather conditions may have errors and greater uncertainty.

As a result of the predicted weather conditions being incorrect, an incorrect amount of electricity (that will be output by the power plant) may be predicted. Predicting the incorrect amount of power to be provided to the data center may disrupt an operation of the data center, create inefficiencies in operation or incur additional financial costs. For example, as a result of predicting the incorrect amount of power, computational workloads may be delayed or may be canceled. Changes in scheduling such workloads may result in using electricity during a period of time when the costs are higher. Changes in scheduling such workloads may result in service level agreements not being met, which incur financial penalties.

Computing resources, network resources, and/or storage resources, among other examples, may be consumed in order to reschedule the computational workloads that are delayed, in order to troubleshoot a reason for the computational workloads that are canceled, in order to reconfigure the data center to prevent additional disruptions with respect to additional workloads, among other examples. Therefore, predicting weather conditions incorrectly may degrade the operation of the data center. Accordingly, there is a need for accurate predictions of weather conditions to enable computational workloads to be executed without disruption as well as to reduce costs.

### SUMMARY

In some implementations, a computer-implemented method performed by a data center management system includes predicting localized weather conditions for a location of a data center during a period of time; determining whether the localized weather conditions will degrade an operation of the data center during the period of time; obtaining computational workload information identifying one or more computational workloads scheduled for execution at the data center during the period of time; determining, based on the computational workload information, one or more priorities associated with the one or more computational workloads; and scheduling the one or more computational workloads for execution based on the one or more priorities and based on determining whether the localized weather conditions will degrade the operation of the data center.

In some implementations, the method further includes determining a first priority associated with a first computational workload of the one or more computational workloads; determining a second priority associated with a second computational workload of the one or more computational workloads. The first priority exceeds the second priority. Scheduling the one or more computational workloads comprise determining that the localized weather conditions will degrade the operation of the data center; causing the first computational workload to be executed during the period of time based on the first priority; and causing the second computational workload to be executed after the period of time based on the second priority.

An advantage of determining the schedules for execution of the computational workload based on the priorities is preserving computing resources, network resources, and/or storage resources, among other examples, that would have otherwise been consumed in order to reschedule the computational workloads that are delayed, in order to troubleshoot a reason for the computational workloads that are canceled, in order to reconfigure the data center to prevent additional disruptions with respect to additional workloads or degradation with respect to the quality of the service provided by those workloads, among other examples.

In some implementations, a computer program product for managing computational workloads includes one or more computer readable storage media, and program instructions collectively stored on the one or more computer readable storage media, the program instructions comprising: program instructions to predict localized weather conditions for a location of a data center during a period of time; program instructions to determine that the localized weather conditions will degrade an operation of a portion of the data center during the period of time; program instructions to determine a first priority associated with a first computational workload of a plurality of computational workloads to be executed during the period of time; program instructions to determine a second priority associated with a second computational workload of the plurality of computational workloads; and program instructions to schedule the first computational workload and the second computational workload based on the first priority, the second priority, and determining that the localized weather conditions will degrade the operation of a portion of the data center.

An advantage of determining the schedules for execution of the computational workload based on the priorities is preserving computing resources, network resources, and/or storage resources, among other examples, that would have otherwise been consumed in order to reschedule the computational workloads that are delayed, in order to troubleshoot a reason for the computational workloads that are canceled, in order to reconfigure the data center to prevent additional disruptions with respect to additional workloads or degradation with respect to the quality of the service provided by those workloads, among other examples. Another advantage of determining the schedules for execution of the computational workload based on the priorities is improving a measure of resiliency and/or a measure of continuity of operations at the data center (e.g., with respect to executing the computational workloads).

In some implementations, a system comprising: a data center including a plurality of computing nodes; and a data center management system configured to: predict localized weather conditions for a location of the data center during a period of time; determine that the localized weather conditions will degrade an operation of the data center during the period of time; determine a first priority associated with a first computational workload of a plurality of computational workloads to be executed during the period of time; determine a second priority associated with a second computational workload of the plurality of computational workloads; and schedule the first computational workload and the second computational workload based on the first priority, the second priority, and determining that the localized weather conditions will degrade the operation of the data center.

In some examples, when scheduling the first computational workload and the second computational workload, the data center management system is further configured to cause, using a machine learning model, the first computational workload to be executed during the period of time based on the first priority; and cause, using the machine learning model, the second computational workload to be executed after the period of time based on the second priority.

An advantage of determining the schedules for execution of the computational workload based on the priorities is preserving computing resources, network resources, and/or storage resources, among other examples, that would have otherwise been consumed in order to reschedule the computational workloads that are delayed, in order to troubleshoot a reason for the computational workloads that are canceled, in order to reconfigure the data center to prevent additional disruptions with respect to additional workloads, or degradation with respect to the quality of the service provided by those workloads among other examples.

### BRIEF DESCRIPTION OF THE DRAWINGS

FIGS. 1A-1F are diagrams of an example implementation described herein.

FIG. 2 is a diagram of an example environment in which systems and/or methods described herein may be implemented.

FIG. 3 is a diagram of example components of one or more devices of FIG. 2.

FIG. 4 is a flowchart of an example process relating to managing an operation of a data center based on localized weather conditions predicted for the data center.

### DETAILED DESCRIPTION

The following detailed description of example implementations refers to the accompanying drawings. The same reference numbers in different drawings may identify the same or similar elements.

Implementations described herein are directed to predicting localized weather conditions for a location of a data center during a period of time and using the localized weather conditions to control an operation of the data center during the period of time. The term “localized weather conditions” (or “highly localized weather conditions”) may be used to refer to weather conditions that are specific to a particular location as opposed to general weather conditions for a large geographical area such as an area covered by a state, county, city or five-digit zip code. In some examples, the weather conditions, for the particular location, may cover an area that is approximately one kilometer by approximately one kilometer, approximately half a kilometer by approximately a half a kilometer, approximately a quarter of kilometer by approximately a quarter of kilometer, and/or a smaller area.

In the context of a data center, the localized weather conditions for a location of the data center may refer to weather conditions that are specific to the location of the data center. For instance, the localized weather conditions for the location of the data center may refer to weather conditions that are specific to an area corresponding to geographical boundaries of the data center (e.g., pre-determined geographical boundaries of the data center). The geographical boundaries may correspond to geographical coordinates of the data center. Similarly, the term “localized environmental conditions” may be used to refer to environment conditions that are specific to the location of the data center as opposed to general environmental conditions for a large geographical area such as an area covered by a state, county, city or five-digit zip code.

In some implementations, a data center management system may predict localized weather and/or environment conditions, during a period of time, for the location of the data center. The localized weather and/or environment conditions may include temperature, relative humidity, solar irradiance, air quality, water quality, precipitation amount, intensity or type, wind speed and direction, lightning, proximity of storms, among other examples. In some situations, the data center management system may provide weather information regarding the localized weather and/or environment conditions to a building management system of the data center. As an example, the building management system may use the weather information to control temperature and/or humidity of the data center. By controlling the temperature and/or humidity of the data center in this manner, an energy efficiency of the data center may be improved. Additionally, an operational cost associated with the data center may be reduced.

In some situations, the data center management system may determine that the predicted localized weather and/or environment conditions may degrade an operation of the data center during the period of time. For example, the data center management system may determine that the predicted localized weather and/or environment conditions may cause resources, allocated during the period of time, to become partially or completely unavailable (e.g., electrical power sources and/or renewable energy sources, among other examples).

Based on determining that the predicted localized weather and/or environment conditions may degrade the operation of the data center, the data center management system may identify computational workloads scheduled for execution during the period of time and/or scheduled to generate results during the period of time. The data center management system may determine priorities associated with the computational workloads. The data center management system may determine schedules for execution of the computational workload based on the priorities.

For example, based on the priorities, the data center management system may cause one or more of the computational workloads to be executed during the period of time (e.g., executed at the data center or executed at another data center), cause one or more of the computational workloads to be reschedule for execution (e.g., to another period of time that is subsequent to the period of time), and/or cause one or more of the computational workloads to be canceled. In some examples, the data center management system may determine the schedules for execution based on a machine learning model. As an example, the machine learning model may be trained to predict a likelihood of degradation of the operation of the data center based on predicted weather and environmental conditions.

In some situations, the degradation of the operation of the data center may cause a disruption of the operation of the data center. Accordingly, the term “degrade” may include “disrupt” and the term “degradation” may include “disruption.” An advantage of determining the schedules for execution of the computational workload based on the priorities is improving a measure of resiliency and/or a measure of continuity of operations at the data center (e.g., with respect to executing the computational workloads).

Another advantage of determining the schedules for execution of the computational workload based on the priorities is preserving computing resources, network resources, and/or storage resources, among other examples, that would have otherwise been consumed in order to reschedule the computational workloads that are delayed, in order to troubleshoot a reason for the computational workloads that are canceled, in order to reconfigure the data center to prevent additional disruptions with respect to additional workloads, among other examples.

In some examples, the data center management system may use the predicted localized weather and/or environment conditions to predict an amount of energy to be generated by a source of renewable energy associated with the data center. The source of renewable energy may include solar panels and/or farms, wind turbines, and/or farms, among other examples. In some instances, the data center management system may provide information regarding the predicted amount of energy to the building management to enable the building management to control the temperature of the data center based on the predicted amount of energy. Additionally, or alternatively, the data center management system may determine the schedules for execution of the computational workloads based on the predicted amount of energy.

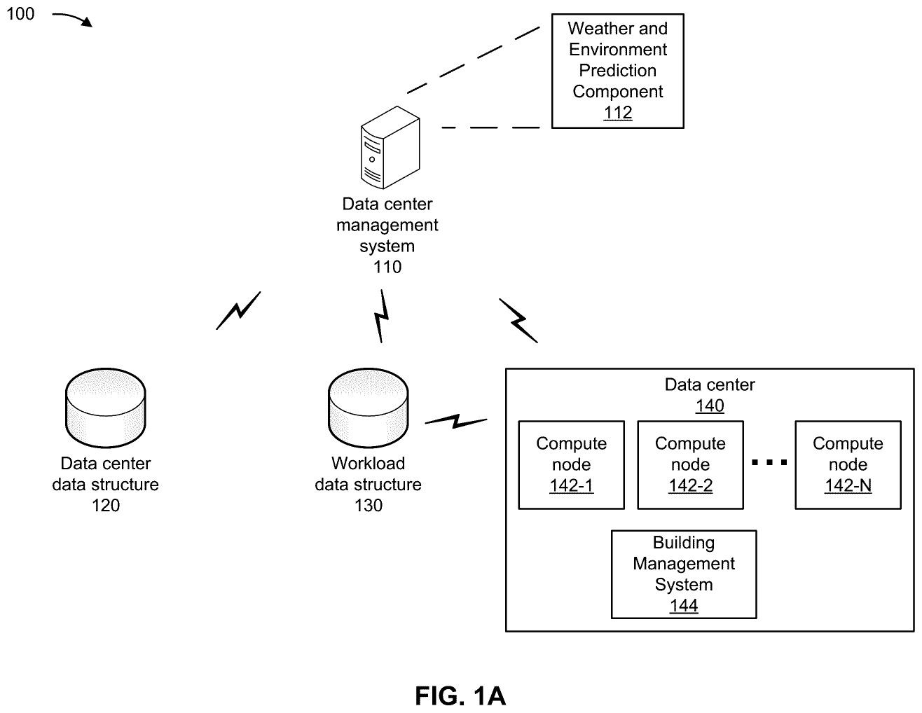

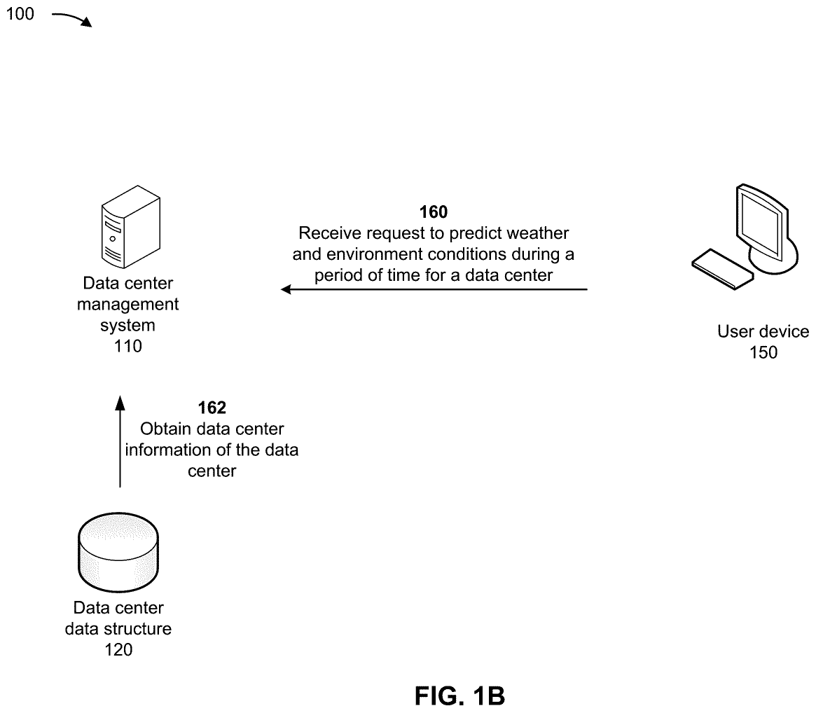

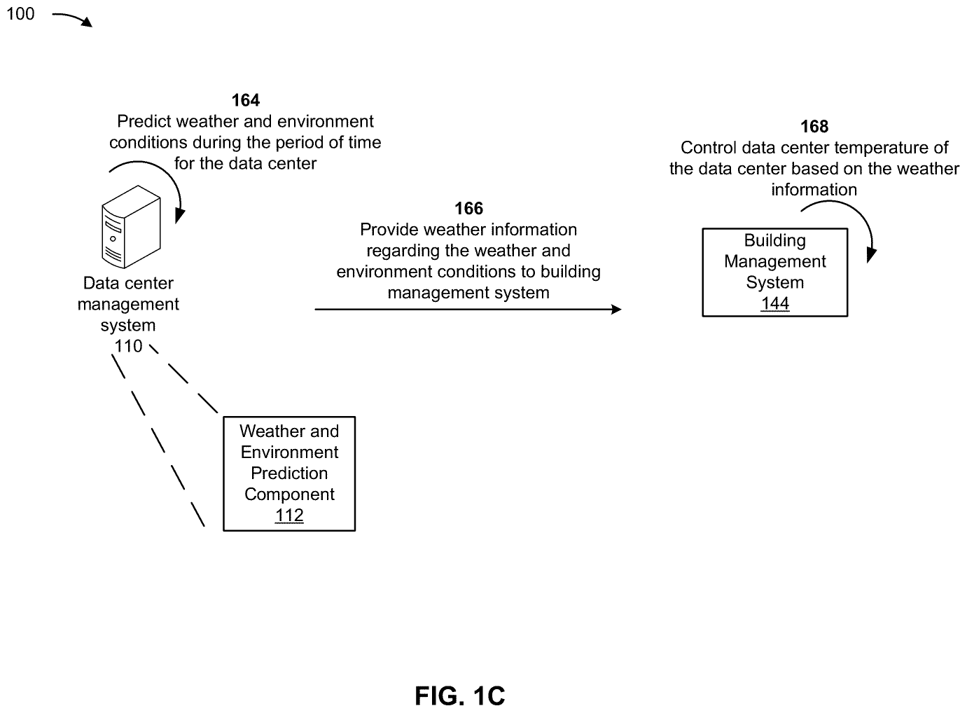

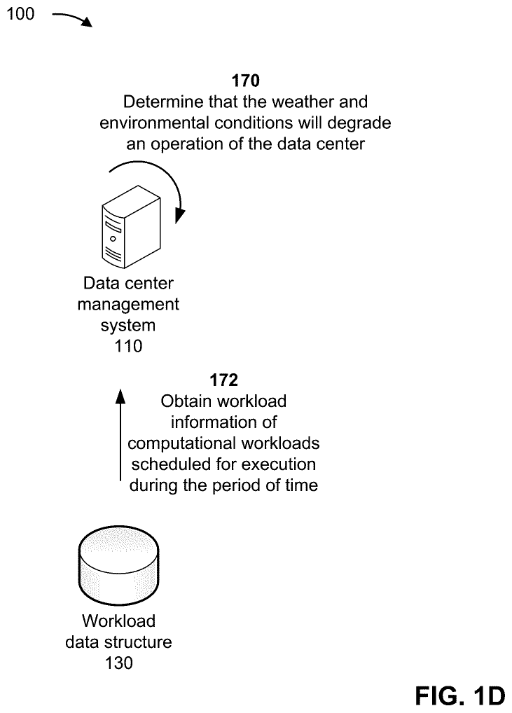

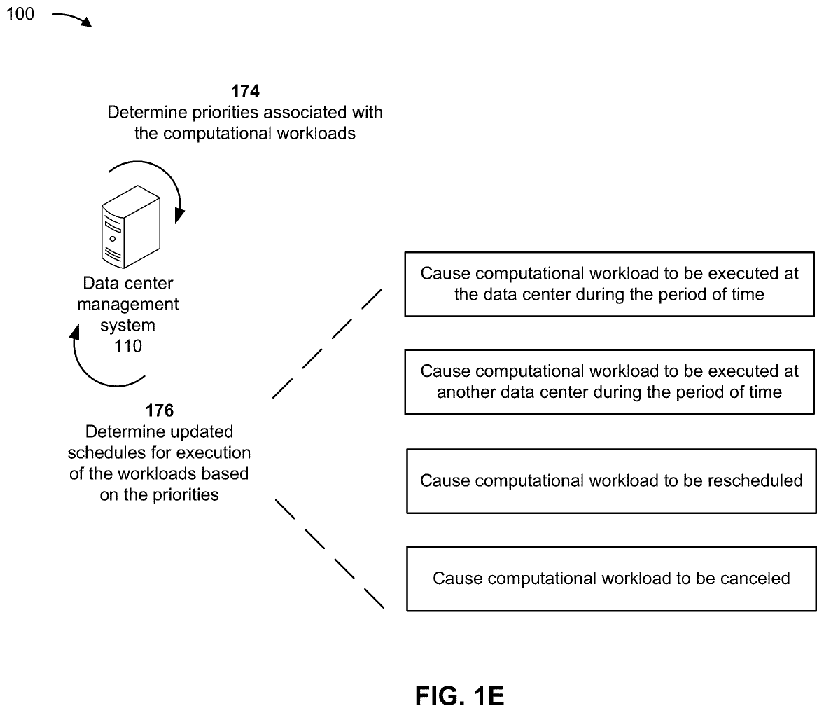

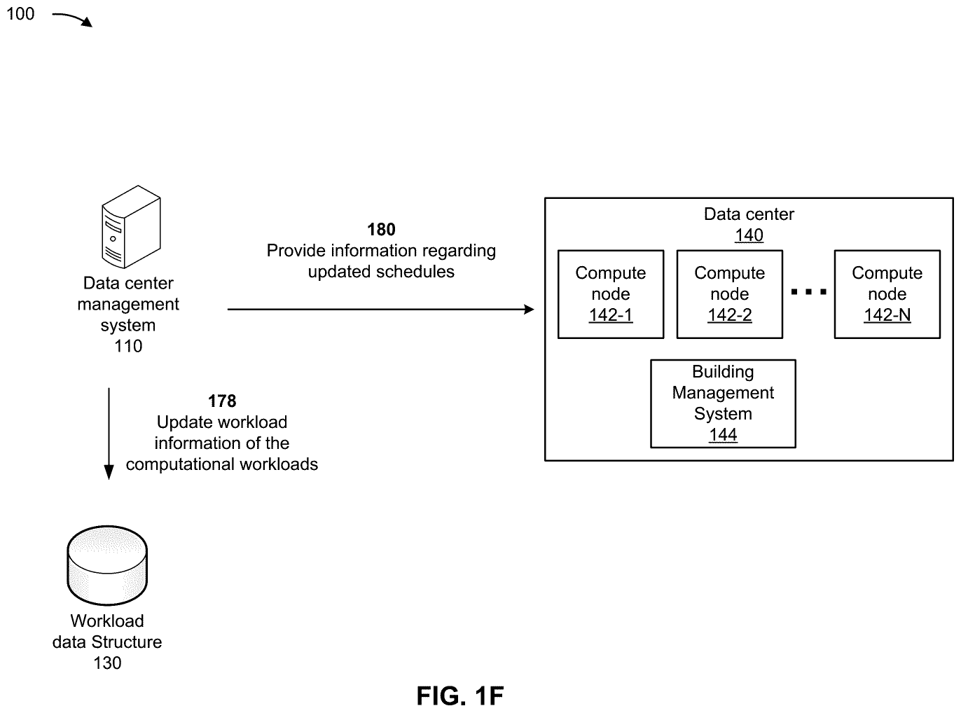

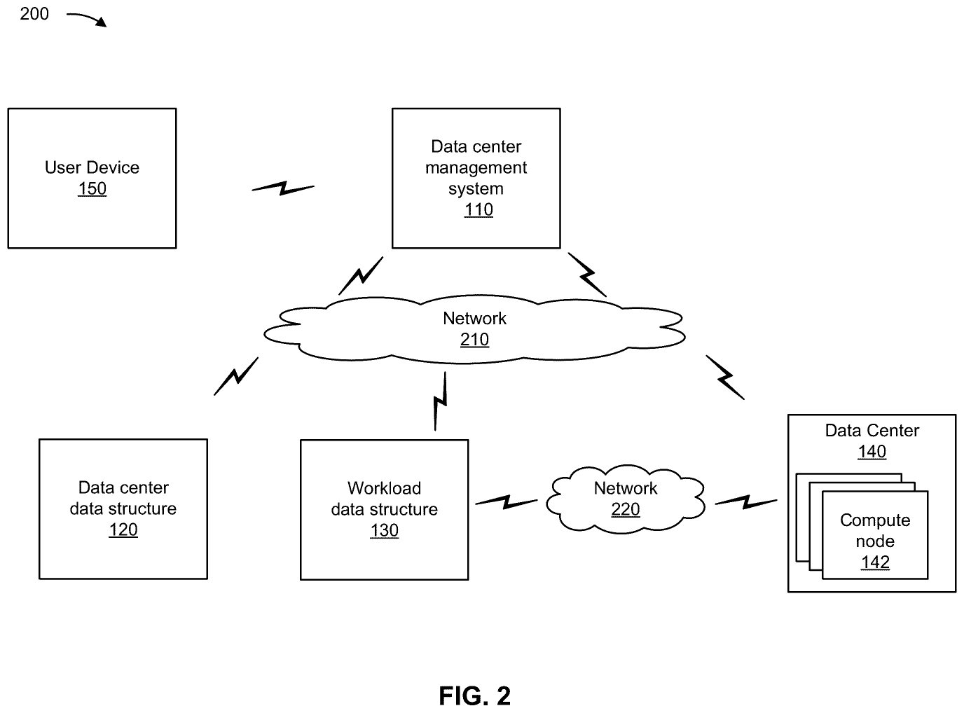

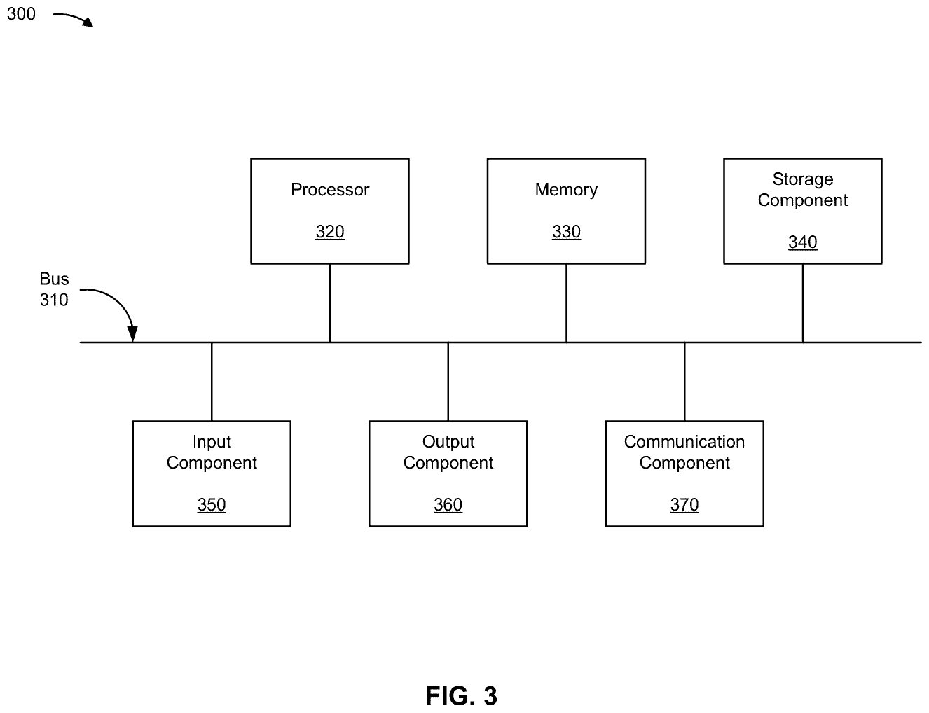

FIGS. 1A-1F are diagrams of an example implementation 100 described herein. As shown in FIGS. 1A-1F, example implementation 100 includes a data center management system 110, a data center data structure 120, a workload data structure 130, a data center 140, and a user device 150. These devices are described in more detail below in connection with FIG. 2 and FIG. 3.

Data center management system 110 may include one or more devices configured to predict localized weather and/or environment conditions for a data center (e.g., data center 140) during a period of time and cause an operation of the data center to be adjusted based on the predicted localized weather and/or environment conditions, as explained herein. As shown in FIG. 1A, data center management system 110 may include weather and environment prediction component 112. Weather and environment prediction component 112 may include one or more devices configured to predict localized weather and/or environment conditions, during a particular time, for a location.

In some implementations, weather and environment prediction component 112 may include a prediction model. In some examples, the prediction model may be trained based on historical data that includes historical weather measurements or predictions regarding weather and/or environmental conditions at the location of the data center and/or historical device data from devices provided at the location. The historical weather data may be obtained from various sources such as weather stations, transportation hubs (e.g., airports and/or maritime ports), web sites, among other sources. The weather station and transportation hubs may include devices or sensors configured to sense weather and/or environment conditions and to provide data regarding the weather and/or environment conditions.

Data center data structure 120 may include a database, a table, a queue, and/or a linked list that stores data center information regarding different data centers. As an example, the data center information, of the data center, may include information identifying the data center, location information identifying the location of the data center, information regarding computing nodes of the data center, information identifying computational workloads scheduled for execution by the computing nodes of the data center, geographical information associated with the data center, among other examples.

In some examples, the location information may include geographical coordinates of boundaries of the data center. In some examples, the geographical information may include information regarding a population density of an area surrounding the location of the data center, information regarding bodies of water in the area, information regarding a density of vegetation (e.g., trees) in the area, and/or information indicating whether the area is an urban area or a rural area, among other examples.

Workload data structure 130 may include a database, a table, a queue, and/or a linked list that stores workload information regarding computational workloads. As an example, the workload information of a computational workload may include information identifying the computational workload, information identifying a priority associated with the computational workload, information identifying a time scheduled for execution of the computational workload, and/or information identifying a time for delivery of a result of executing the computational workload, among other examples.

In some implementations, the priority may be based on an operation cost associated with executing the computational workload. The operation cost may include energy cost, cost of computing nodes, cost of additional hardware, and/or cost of software, among other examples. Additionally, or alternatively, the priority may be based on a service level agreement associated with the computational workload. Additionally, or alternatively, the priority may be based on a quality of service associated with the computational workload.

As shown in FIG. 1A, data center 140 may include a plurality of computing nodes 142 (individually “computing node 142”) and a building management system 144. A computing node 142 may be include one or more devices configured to execute a workload, a portion of a workload (e.g., a job), and/or a portion of a job based on instructions. A computing node 142 may include a communication device and a computing device. For example, a computing node 142 may include a server device, a laptop computer, a desktop computer, and/or a similar type of device. Building management system 144 may include one or more devices configured to control a heating, ventilation, and air conditioning (HVAC) system of a data center. Additionally, or alternatively, building management system 144 may control operations of lights, window shades, elevators, escalators and/or other equipment that consumes electricity, among other examples.

As shown in FIG. 1B, example implementation 100 includes user device 150. User device 150 may include one or more devices capable of receiving, generating, storing, processing, and/or providing information regarding a job to be executed, as described elsewhere herein. User device 150 may include a communication device and a computing device. For example, user device 150 may include a wireless communication device, a mobile phone, a user equipment, a laptop computer, a tablet computer, a desktop computer, or a similar type of device.

As shown in FIG. 1B, and by reference number 160, data center management system 110 may receive a request to predict weather and environment conditions during a period of time for a data center. In some examples, the request may include information identifying data center 140 and information identifying the period of time. The period of time may include a day, the type of day (e.g., workday, holiday, or weekend), a particular time of a day, a range of times of day, morning time, afternoon time, evening time, among other examples. In some implementations, data center management system 110 may receive the request from user device 150, which may be a device an administrator of data center 140.

As shown in FIG. 1B, and by reference number 162, data center management system 110 may obtain data center information of the data center. For example, data center management system 110 may obtain the data center information of data center 140 based on receiving the request from user device 150. Alternatively, data center management system 110 may obtain the data center information periodically (e.g., every ten minutes, every twenty minutes, among other examples).

In some examples, data center management system 110 may obtain the data center information by performing of a lookup of data center data structure 120. For instance, data center management system 110 perform the lookup using the information identifying data center 140 included in the request.

As shown in FIG. 1C, and by reference number 164, data center management system 110 may predict weather and environment conditions during the period of time for the data center. For example, based on the data center information of data center 140, data center management system 110 may predict weather and environment conditions during the period of time. In some implementations, data center management system 110 may predict the weather and environment conditions using weather and environment prediction component 112. For example, data center management system 110 may provide, as an input to weather and environment prediction component 112, the location information and/or the geographical information.

The location information may be used to determine the geographical boundaries of data center 140. The geographical information may be used to identify the population density of an area surrounding the location of data center 140, the bodies of water included the area, a density of vegetation (e.g., trees) in the area, and/or a type of the area (urban area or a rural area) that may affect the weather and environmental conditions at the location of data center 140. For example, a first area with a first population density may be cooler (temperature wise) than a second area with a second population density that exceeds the first population density. As another example, a third area that includes bodies of water may be cooler (temperature wise) than a fourth area that does not include bodies of water.

As shown in FIG. 1C, and by reference number 166, data center management system 110 may provide weather information regarding the weather and environment conditions to building management system 144. For example, data center management system 110 may provide the weather information to building management system 144 to enable building management system 144 to control a data center temperature of data center 140. In some instances, the weather information may include information identifying a temperature for the location of data center 140, an amount of humidity for the location of data center 140, and/or an amount of solar irradiance for the location of data center 140, among other examples.

As shown in FIG. 1C, and by reference number 168, building management system 144 may control the temperature and humidity of the data center based on the weather information. For example, if the weather information indicates the weather, at the data center, is predicted to be cool and dry, building management system 144 may set the data center temperature to a first temperature. Alternatively, if the weather information indicates the weather, at the data center, is predicted to be hot and humid, building management system 144 may set the data center temperature to a second temperature that exceeds the first temperature. Additionally, building management system 144 may cause lights in data center 140 to be turned off, may cause window shades to be lowered, among other examples.

In some examples, the weather information may predict an amount of power to be generated by a source of renewable energy at data center 140. The source of renewable energy may include solar panels and/or wind turbines, among other examples. For example, the weather information may predict a first amount of power when the weather is predicted to be cloudy (e.g., based on a predicted amount of solar irradiance). Alternatively, the weather information may predict a second amount of power (that exceeds the first amount of power) when the weather is predicted to be sunny (e.g., based on a predicted amount of solar irradiance). For example, building management system 144 may adjust an amount of energy consumption based on the predicted amount of power. For instance, building management system 144 may reduce the amount of energy consumption when the predicted amount of power is the first amount of power.

In some examples, the weather information, used by building management system 144, may predict environmental impacts. For example, a temperature and a measure of humidity (predicted by the weather information) may impact a cooling capability of data center 140. As another example, a velocity of wind and an amount of precipitation (predicted by the weather information) may impact power supply continuity. As yet another example, a measure of solar irradiance may directly impact heat loading and local renewable generation capability of data center 140. Building management system 144 may use the weather information to adjust the HVAC system, the lights, and/or the window shades (among other examples) to address the impacts. In some situations, coupling renewable power generation and data center operations and demand to localized predictive weather and environmental analytics can enable better operational contingencies of data center 140.

In some examples, the weather information may be used to optimize facility and data center energy expenditure by adjusting cost and priority associated with computational workloads. As an example, a dynamic costing and priority schema would optimize finite data center resources (compute cycles as a function of relative power and cooling costs) enabling increased reliability and lowest relative cost. In the case of a broader cloud infrastructure costing impacts (lower cost structure) could be distributed over a wider resource pool thereby enabling more flexibility in cost and scheduling.

As shown in FIG. 1D, and by reference number 170, data center management system 110 may determine that the weather and environmental conditions will degrade an operation of data center 140. For example, data center management system 110 may determine that the weather and environmental conditions, predicted for data center 140 during the period of time, will interrupt electrical power supplied to data center 140, will decrease the electrical power supplied to data center 140, and/or will decrease the amount of power generated by the source of renewable energy, among other types of disruption. In some implementations, data center management system 110 use a machine learning model to determine that the weather and environmental conditions will degrade the operation of data center 140.

As an example, the machine learning model may be trained to predict a likelihood of disruption or degradation of the operation of the data center based on the predicted weather and environmental conditions. For instance, the machine learning model may be trained to predict a measure of severity of the predicted weather and environmental conditions. The machine learning model may be trained based on historical data that includes historical data regarding weather, historical data regarding weather conditions, and/or historical data regarding disruptions of operations of data center 140, among other examples.

In some examples, data center management system 110 may determine that the weather and environmental conditions will degrade an operation of a portion of data center 140. For instance, data center management system 110 may determine that the weather and environmental conditions will degrade an operation of a first portion of data center 140 while an operation of a second portion of data center 140 remains unaffected by the weather and environmental conditions. Such an instance may occur when data center 140 spans more than one kilometer, as an example.

As shown in FIG. 1D, and by reference number 172, data center management system 110 may obtain workload information of computational workloads scheduled for execution during the period of time. For example, based on determining that the weather and environmental conditions will degrade the operation of data center 140, data center management system 110 may identify computational workloads scheduled for execution, at data center 140, during the period of time.

In some instances, data center management system 110 may perform a lookup of workload data structure 130 and obtain the workload information the computational workloads based on the lookup. For example, data center management system 110 obtain first workload information of a first computational workload of the computational workloads, second workload information of a second computational workload of the computational workloads, among other examples. Data center management system 110 may perform the lookup using the information identifying the period of time and the information identifying the computational workloads identified in the data center information of data center 140.

As shown in FIG. 1E, and by reference number 174, data center management system 110 may determine priorities associated with the computational workloads. For example, based on the workload information, data center management system 110 may determine the priorities associated with the computational workloads. For example, data center management system 110 may determine a first priority associated with the first computational workload based on the first workload information, determine a second priority associated with the second computational workload based on the second workload information, and so on. As an example, data center management system 110 may determine that the first priority may exceed the second priority. For example, data center management system 110 may determine that the first priority is ranked higher than the second priority. In other words, data center management system 110 may determine that the first priority is a priority that is higher than the second priority.

As shown in FIG. 1E, and by reference number 176, data center management system 110 may updated schedules for execution of the workloads based on the priorities. For example, based on the priorities associated with the computational workloads, data center management system 110 may determine a computational workload that is to be executed during the period of time, a computational workload that is to be rescheduled (e.g., for execution after the period of time), and/or a computational workload that is to be canceled. In some situations, data center management system 110 may make the determinations, mentioned above, using the machine learning model trained to predict the likelihood of disruption of the operation of the data center.

As an example, data center management system 110 may determine the first priority is a highest priority out of priorities typically associated with computational workloads. In other words, data center management system 110 may determine that the first priority is a priority that is higher than all other priorities typically associated with the computational workloads. Accordingly, data center management system 110 may determine that the first computational workload is to be executed during the period of time (e.g., to comply with the service level agreement associated with the first computational workload, to comply with the quality of service associated with the first computational workload, to meet the time of delivery associated with the first computational workload, among other examples). In some examples, data center management system 110 may cause the first computational workload to be executed at data center 140 (e.g., at a portion of data center 140 that is not affected by the weather and environmental conditions).

In some examples, data center management system 110 may determine that the weather and environmental conditions will prevent any computational workload from being executed at data center 140 during the period of time. Accordingly, data center management system 110 may identify another data center at another location that is not subject to the weather and environmental conditions and cause the first computation workload to be executed at such data center. Such data center may include computing nodes that are capable of executing the first computational workload. In some examples, data center 140 may be a first cloud instance and the other data center may a second cloud instance.

In some examples, data center management system 110 may determine that the second priority is a priority indicating that the second computational workload is to be rescheduled (e.g., due to limited resources available at data center 140 during the period of time). Accordingly, data center management system 110 may cause the second computational workload to be rescheduled to another period of time subsequent to the period of time identified by the request.

In some examples, data center management system 110 may determine a third priority, associated with a third computational workload of the computational workloads, is a lowest priority of priorities typically associated with computational workloads. Accordingly, data center management system 110 may determine that the third computational workload is to be canceled (e.g., due to limited resources available at data center 140 during the period of time).

As shown in FIG. 1F, and by reference number 178, data center management system 110 may update workload information of the computational workloads. For example, data center management system 110 may update the first workload information to indicate that the first computational workload is to be executed at data center 140 or another data center, update the second workload information to indicate that the second computational workload is to be rescheduled, update third workload information to indicate that the third computational workload is to be canceled, among other examples. Data center management system 110 may provide the updated workload information to workload data structure 130. In some examples, the updated workload information may be used to maintain continuity and/or ensure resiliency (e.g., with respect to execution of the computational workloads)

As shown in FIG. 1F, and by reference number 180, data center management system 110 may provide information regarding the updated schedules. For example, after updating the schedules, data center management system 110 may provide information regarding the updated schedules to data center 140 and/or to another data center to cause the computational workloads to be executed and/or canceled accordingly.

Additional examples of mitigation actions are workload shedding, rescheduling or movement to another data center or cloud instance can be planned to meet normal operational (e.g., quality of service, local operating cost, etc.) as well as other impact metrics based upon local weather or environmental factors.

By determining the schedules for execution of the computational workload based on the priorities, the data center management system 110 may improve a measure of resiliency and/or a measure of continuity of operations at the data center (e.g., with respect to executing the computational workloads).

By determining the schedules for execution of the computational workload based on the priorities, the data center management system 110 may preserve computing resources, network resources, and/or storage resources, among other examples, that would have otherwise been consumed in order to reschedule the computational workloads that are delayed, in order to troubleshoot a reason for the computational workloads that are canceled, in order to reconfigure the data center to prevent additional disruptions with respect to additional workloads, among other examples.

The present invention may be a system, a method, and/or a computer program product at any possible technical detail level of integration. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

As indicated above, FIGS. 1A-1F are provided as an example. Other examples may differ from what is described with regard to FIGS. 1A-1F. The number and arrangement of devices shown in FIGS. 1A-1F are provided as an example. A network, formed by the devices shown in FIGS. 1A-1F may be part of a network that comprises various configurations and uses various protocols including local Ethernet networks, private networks using communication protocols proprietary to one or more companies, cellular and wireless networks (e.g., Wi-Fi), instant messaging, hypertext transfer protocol (HTTP) and simple mail transfer protocol (SMTP, and various combinations of the foregoing.

There may be additional devices (e.g., a large number of devices), fewer devices, different devices, or differently arranged devices than those shown in FIGS. 1A-1F. Furthermore, two or more devices shown in FIGS. 1A-1F may be implemented within a single device, or a single device shown in FIGS. 1A-1F may be implemented as multiple, distributed devices. Additionally, or alternatively, a set of devices (e.g., one or more devices) shown in FIGS. 1A-1F may perform one or more functions described as being performed by another set of devices shown in FIGS. 1A-1F.

FIG. 2 is a diagram of an example environment 200 in which systems and/or methods described herein can be implemented. As shown in FIG. 2, environment 200 may include data center management system 110, data center data structure 120, workload data structure 130, data center 140 that includes a plurality of computing nodes 142, and user device 150. Data center management system 110, data center data structure 120, workload data structure 130, data center 140 have been described above in connection with FIG. 1. Devices of environment 200 can interconnect via wired connections, wireless connections, or a combination of wired and wireless connections.

Data center management system 110 may include a communication device and a computing device. For example, data center management system 110 includes computing hardware used in a cloud computing environment. In some examples, data center management system 110 may include a server, such as an application server, a client server, a web server, a database server, a host server, a proxy server, a virtual server (e.g., executing on computing hardware), or a server in a cloud computing system.

Computing node 142 may include a communication device and a computing device. For example, computing node 142 includes computing hardware used in a cloud computing environment. In some examples, computing node 142 may include a server, such as an application server, a client server, a web server, a database server, a host server, a proxy server, a virtual server (e.g., executing on computing hardware), or a server in a cloud computing system.

Network 210 includes one or more wired and/or wireless networks. For example, network 210 may include Ethernet switches. Additionally, or alternatively, network 210 may include a cellular network, a public land mobile network (PLMN), a local area network (LAN), a wide area network (WAN), a private network, the Internet, and/or a combination of these or other types of networks. Network 210 enables communication between data center management system 110, data center data structure 120, workload data structure 130, and data center 140.

Network 220 includes one or more wired and/or wireless networks. For example, network 220 may include a cellular network, a public land mobile network (PLMN), a local area network (LAN), a wide area network (WAN), a private network, the Internet, and/or a combination of these or other types of networks. Network 220 enables communication among workload data structure 130 and data center 140, as shown in FIG. 2. In some implementations, network 210 may additionally enable communication between data center management system 110, data center data structure 120, workload data structure 130, and data center 140. Alternatively, network 210 may additionally enable communication among workload data structure 130 and data center 140. In other words, either network 210 or network 220 may enable communication between the devices identified in FIG. 2.

The number and arrangement of devices and networks shown in FIG. 2 are provided as an example. In practice, there can be additional devices and/or networks, fewer devices and/or networks, different devices and/or networks, or differently arranged devices and/or networks than those shown in FIG. 2. Furthermore, two or more devices shown in FIG. 2 can be implemented within a single device, or a single device shown in FIG. 2 can be implemented as multiple, distributed devices. Additionally, or alternatively, a set of devices (e.g., one or more devices) of environment 200 can perform one or more functions described as being performed by another set of devices of environment 200.

FIG. 3 is a diagram of example components of a device 300, which may correspond to data center management system 110, data center data structure 120, workload data structure 130, and/or data center 140. In some implementations, data center management system 110, data center data structure 120, workload data structure 130, and/or data center 140 may include one or more devices 300 and/or one or more components of device 300. As shown in FIG. 3, device 300 may include a bus 310, a processor 320, a memory 330, a storage component 340, an input component 350, an output component 360, and a communication component 370.

Bus 310 includes a component that enables wired and/or wireless communication among the components of device 300. Processor 320 includes a central processing unit, a graphics processing unit, a microprocessor, a controller, a microcontroller, a digital signal processor, a field-programmable gate array, an application-specific integrated circuit, and/or another type of processing component. Processor 320 is implemented in hardware, firmware, or a combination of hardware and software. In some implementations, processor 320 includes one or more processors capable of being programmed to perform a function. Memory 330 includes a random access memory, a read only memory, and/or another type of memory (e.g., a flash memory, a magnetic memory, and/or an optical memory).

Storage component 340 stores information and/or software related to the operation of device 300. For example, storage component 340 may include a hard disk drive, a magnetic disk drive, an optical disk drive, a solid state disk drive, a compact disc, a digital versatile disc, and/or another type of non-transitory computer-readable medium. Input component 350 enables device 300 to receive input, such as user input and/or sensed inputs. For example, input component 350 may include a touch screen, a keyboard, a keypad, a mouse, a button, a microphone, a switch, a sensor, a global positioning system component, an accelerometer, a gyroscope, and/or an actuator. Output component 360 enables device 300 to provide output, such as via a display, a speaker, and/or one or more light-emitting diodes. Communication component 370 enables device 300 to communicate with other devices, such as via a wired connection and/or a wireless connection. For example, communication component 370 may include a receiver, a transmitter, a transceiver, a modem, a network interface card, and/or an antenna.

Device 300 may perform one or more processes described herein. For example, a non-transitory computer-readable medium (e.g., memory 330 and/or storage component 340) may store a set of instructions (e.g., one or more instructions, code, software code, and/or program code) for execution by processor 320. Processor 320 may execute the set of instructions to perform one or more processes described herein. In some implementations, execution of the set of instructions, by one or more processors 320, causes the one or more processors 320 and/or the device 300 to perform one or more processes described herein. In some implementations, hardwired circuitry may be used instead of or in combination with the instructions to perform one or more processes described herein. Thus, implementations described herein are not limited to any specific combination of hardware circuitry and software.

The number and arrangement of components shown in FIG. 3 are provided as an example. Device 300 may include additional components, fewer components, different components, or differently arranged components than those shown in FIG. 3. Additionally, or alternatively, a set of components (e.g., one or more components) of device 300 may perform one or more functions described as being performed by another set of components of device 300.

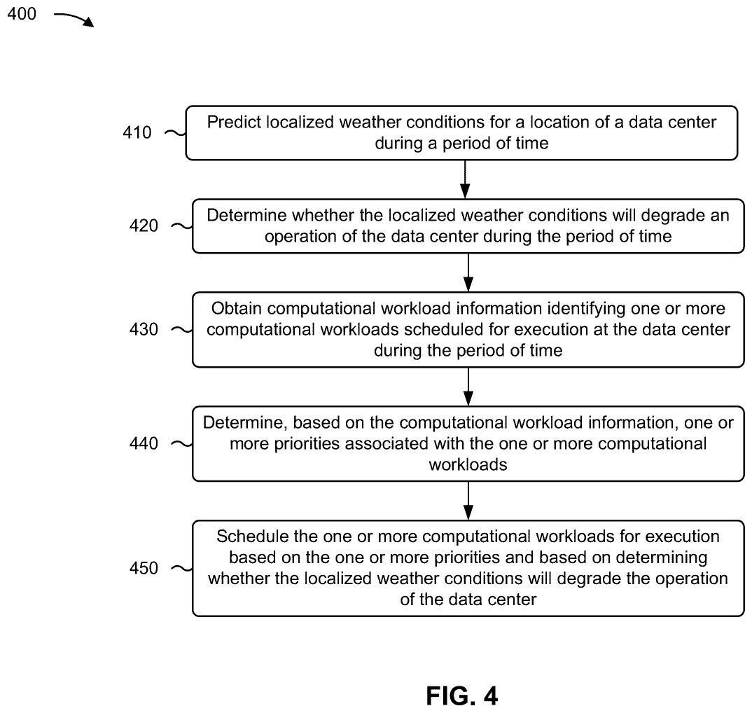

FIG. 4 is a flowchart of an example process 400 relating to managing an operation of a data center based on localized weather conditions predicted for the data center. In some implementations, one or more process blocks of FIG. 4 may be performed by a data center management system (e.g., data center management system 110). In some implementations, one or more process blocks of FIG. 4 may be performed by another device or a group of devices separate from or including the data center management system, such as a data center (e.g., data center 140) and/or a user device (e.g., user device 150). Additionally, or alternatively, one or more process blocks of FIG. 4 may be performed by one or more components of device 300, such as processor 320, memory 330, storage component 340, input component 350, output component 360, and/or communication component 370.

As shown in FIG. 4, process 400 may include predicting localized weather conditions for a location of a data center during a period of time (block 410). For example, the data center management system may predict localized weather conditions for a location of a data center during a period of time, as described above.

As further shown in FIG. 4, process 400 may include determining whether the localized weather conditions will degrade an operation of the data center during the period of time (block 420). For example, the data center management system may determine whether the localized weather conditions will degrade an operation of the data center during the period of time, as described above.

As further shown in FIG. 4, process 400 may include obtaining computational workload information identifying one or more computational workloads scheduled for execution at the data center during the period of time (block 430). For example, the data center management system may obtain computational workload information identifying one or more computational workloads scheduled for execution at the data center during the period of time, as described above.

As further shown in FIG. 4, process 400 may include determining, based on the computational workload information, one or more priorities associated with the one or more computational workloads (block 440). For example, the data center management system may determine, based on the computational workload information, one or more priorities associated with the one or more computational workloads, as described above.

As further shown in FIG. 4, process 400 may include scheduling the one or more computational workloads for execution based on the one or more priorities and based on determining whether the localized weather conditions will degrade the operation of the data center (block 450). For example, the data center management system may schedule the one or more computational workloads for execution based on the one or more priorities and based on determining whether the localized weather conditions will degrade the operation of the data center, as described above.

In some implementations, predicting the localized weather conditions comprises predicting at least one of a temperature or a measure of humidity at the location of the data center, and wherein the method further comprises predicting an amount of energy to be used to decrease a data center temperature at the data center based on the at least one of the temperature or the measure of humidity, and scheduling the one or more computational workloads to be executed by one or more computing nodes of the data center based on the amount of energy to be used to decrease a data center temperature of the data center.

In some implementations, predicting the localized weather conditions comprises predicting at least one of a velocity of wind or an amount of precipitation at the location of the data center, and wherein the method further comprises predicting a continuity of power supplied to the data center based on the at least one of the velocity of wind or the amount of precipitation, and scheduling the one or more computational workloads to be executed by one or more computing nodes of the data center based on the continuity of the power supplied to the data center.

In some implementations, predicting the localized weather conditions comprises predicting an amount of solar irradiance at the location of the data center, and wherein the method further comprises predicting a continuity of power supplied to the data center based on the amount of solar irradiance, and scheduling a computational workload to be executed by one or more computing nodes of the data center based on the continuity of power supplied to the data center.

In some implementations, process 400 may include determining a type of energy for a source of backup power associated with the data center; predicting that the source of backup power will be used based on determining that the localized weather conditions will degrade the operation of the portion of the data center; determine that the type of energy is not to be used; and causing the one or more computational workloads to be executed by one or more computing nodes of a second data center. The type of energy may be from a thermal power generator using fossil fuels and may not be used in order to comply with regulations (e.g., emissions regulations) of an area that includes the data center.

In some implementations, process 400 may include determining an operational cost associated with executing the first computational workload and the second computational workload during the period of time; determining that the operational cost satisfies a cost threshold; causing the first computational workload to be executed during the period of time based on a first priority associated with the first computational workload; and causing the second computational workload after the period of time based on determining that the operational cost satisfies the cost threshold and based on the second priority associated with the second computational workload. In some situations, the operational cost may fluctuate based on a time of day.

Although FIG. 4 shows example blocks of process 400, in some implementations, process 400 may include additional blocks, fewer blocks, different blocks, or differently arranged blocks than those depicted in FIG. 4. Additionally, or alternatively, two or more of the blocks of process 400 may be performed in parallel.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be accomplished as one step, executed concurrently, substantially concurrently, in a partially or wholly temporally overlapping manner, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

As used herein, the term “component” is intended to be broadly construed as hardware, firmware, or a combination of hardware and software. It will be apparent that systems and/or methods described herein may be implemented in different forms of hardware, firmware, and/or a combination of hardware and software. The actual specialized control hardware or software code used to implement these systems and/or methods is not limiting of the implementations. Thus, the operation and behavior of the systems and/or methods are described herein without reference to specific software code—it being understood that software and hardware can be used to implement the systems and/or methods based on the description herein.

As used herein, satisfying a threshold may, depending on the context, refer to a value being greater than the threshold, greater than or equal to the threshold, less than the threshold, less than or equal to the threshold, equal to the threshold, not equal to the threshold, or the like.

Although particular combinations of features are recited in the claims and/or disclosed in the specification, these combinations are not intended to limit the disclosure of various implementations. In fact, many of these features may be combined in ways not specifically recited in the claims and/or disclosed in the specification. Although each dependent claim listed below may directly depend on only one claim, the disclosure of various implementations includes each dependent claim in combination with every other claim in the claim set. As used herein, a phrase referring to “at least one of” a list of items refers to any combination of those items, including single members. As an example, “at least one of: a, b, or c” is intended to cover a, b, c, a-b, a-c, b-c, and a-b-c, as well as any combination with multiple of the same item.

No element, act, or instruction used herein should be construed as critical or essential unless explicitly described as such. Also, as used herein, the articles “a” and “an” are intended to include one or more items, and may be used interchangeably with “one or more.” Further, as used herein, the article “the” is intended to include one or more items referenced in connection with the article “the” and may be used interchangeably with “the one or more.” Furthermore, as used herein, the term “set” is intended to include one or more items (e.g., related items, unrelated items, or a combination of related and unrelated items), and may be used interchangeably with “one or more.” Where only one item is intended, the phrase “only one” or similar language is used. Also, as used herein, the terms “has,” “have,” “having,” or the like are intended to be open-ended terms. Further, the phrase “based on” is intended to mean “based, at least in part, on” unless explicitly stated otherwise. Also, as used herein, the term “or” is intended to be inclusive when used in a series and may be used interchangeably with “and/or,” unless explicitly stated otherwise (e.g., if used in combination with “either” or “only one of”).

What is claimed is:

1. A computer-implemented method performed by a data center management system, the method comprising:
predicting localized weather conditions for a location of a data center during a period of time;
determining whether the localized weather conditions will degrade an operation of the data center during the period of time;
obtaining computational workload information identifying one or more computational workloads scheduled for execution at the data center during the period of time;
determining, based on the computational workload information, one or more priorities associated with the one or more computational workloads; and
scheduling the one or more computational workloads for execution based on the one or more priorities and based on determining whether the localized weather conditions will degrade the operation of the data center.

2. The computer-implemented method of claim 1, wherein determining the one or more priorities comprises:
determining a first priority associated with a first computational workload of the one or more computational workloads;
determining a second priority associated with a second computational workload of the one or more computational workloads,
wherein the first priority exceeds the second priority; and
wherein scheduling the one or more computational workloads comprise:
determining that the localized weather will degrade the operation of the data center;
causing the first computational workload to be executed during the period of time based on the first priority; and
causing the second computational workload to be executed after the period of time based on the second priority.

3. The computer-implemented method of claim 2, further comprising:
determining a third priority associated with a third computational workload of the one or more computational workloads,
wherein the second priority exceeds the third priority; and
causing the third computational workload to be canceled during the period of time based on the third priority.

4. The computer-implemented method of claim 2, wherein the data center is a first data center, and
wherein causing the first computational workload to be executed during the period of time comprises:
identifying a second data center; and
causing the first computational workload to be executed during the period of time at the second data center.

5. The computer-implemented method of claim 1, wherein predicting the localized weather conditions comprises:
predicting at least one of a temperature or a measure of humidity at the location of the data center; and
wherein the method further comprises:
predicting an amount of energy to be used to decrease a data center temperature at the data center based on the at least one of the temperature or the measure of humidity; and
scheduling the one or more computational workloads to be executed by one or more computing nodes of the data center based on the amount of energy to be used to decrease a data center temperature of the data center.

6. The computer-implemented method of claim 1, wherein predicting the localized weather conditions comprises:
predicting at least one of a velocity of wind or an amount of precipitation at the location of the data center; and
wherein the method further comprises:
predicting a continuity of power supplied to the data center based on the at least one of the velocity of wind or the amount of precipitation; and
scheduling the one or more computational workloads to be executed by one or more computing nodes of the data center based on the continuity of the power supplied to the data center.

7. The computer-implemented method of claim 1, wherein predicting the localized weather conditions comprises:
predicting an amount of solar irradiance at the location of the data center; and
wherein the method further comprises:
predicting a continuity of power supplied to the data center based on the amount of solar irradiance; and
scheduling a computational workload to be executed by one or more computing nodes of the data center based on the continuity of power supplied to the data center.

8. A computer program product for managing computational workloads, the computer program product comprising:
one or more computer readable storage media, and program instructions collectively stored on the one or more computer readable storage media, the program instructions comprising:
program instructions to predict localized weather conditions for a location of a data center during a period of time;
program instructions to determine that the localized weather conditions will degrade an operation of a portion of the data center during the period of time;
program instructions to determine a first priority associated with a first computational workload of a plurality of computational workloads to be executed during the period of time;
program instructions to determine a second priority associated with a second computational workload of the plurality of computational workloads; and
program instructions to schedule the first computational workload and the second computational workload based on the first priority, the second priority, and determining that the localized weather conditions will degrade the operation of a portion of the data center.

9. The computer program product of claim 8, wherein the program instructions further comprise:
program instructions to provide weather information, regarding the localized weather conditions, to a building management system of the data center,
wherein the weather information includes information identifying weather conditions at the data center, and
wherein the weather information is provided to the building management system to cause the building management system to control a data center temperature, of the data center, based on the weather information.

10. The computer program product of claim 8, wherein the data center is a first data center, and
wherein the program instructions further comprise:
program instructions to determine a type of energy for a source of backup power associated with the data center;
program instructions to predict that the source of backup power will be used based on determining that the localized weather conditions will degrade the operation of the portion of the data center;
program instructions to determine that the type of energy is not to be used; and
program instructions to cause the one or more computational workloads to be executed by one or more computing nodes of a second data center.

11. The computer program product of claim 10, wherein the program instructions to cause the one or more computational workloads to be executed by the one or more computing nodes of the second data center include:
program instructions to identify the second data center;
program instructions to determine that a location of the second data center is not affected by the localized weather conditions predicted for the first data center; and
program instructions to cause the one or more computational workloads to be executed by the one or more computing nodes of the second data center based on determining that the location of the second data center is not affected by the localized weather conditions predicted for the first data center.

12. The computer program product of claim 8, wherein the program instructions to schedule the first computational workload and the second computational workload include:
program instructions to determine an operational cost associated with executing the first computational workload and the second computational workload during the period of time;
program instructions to determine that the operational cost satisfies a cost threshold;
program instructions to cause the first computational workload to be executed during the period of time based on a first priority associated with the first computational workload; and
program instructions to cause the second computational workload after the period of time based on determining that the operational cost satisfies the cost threshold and based on the second priority associated with the second computational workload.

13. The computer program product of claim 8, wherein the program instructions further include:
program instructions to predict an amount of power to be generated by a source of renewable energy based on the localized weather conditions; and
program instructions to adjust an amount of energy consumption based on the amount of power to be generated by the source of renewable energy.

14. The computer program product of claim 8, wherein the portion of the data center is a first portion, and
wherein the program instructions further include:
program instructions to determine that the localized weather conditions will not disrupt an operation of a second portion of the data center during the period of time; and
cause the first computational workload to be executed by one or more computing nodes of the second portion of the data center during the period of time based on determining that the localized weather conditions will not disrupt the operation of the second portion of the data center.

15. A system comprising:
a data center including a plurality of computing nodes; and
a data center management system configured to:
predict localized weather conditions for a location of the data center during a period of time;
determine that the localized weather conditions will degrade an operation of the data center during the period of time;
determine a first priority associated with a first computational workload of a plurality of computational workloads to be executed during the period of time;
determine a second priority associated with a second computational workload of the plurality of computational workloads; and
schedule the first computational workload and the second computational workload based on the first priority, the second priority, and determining that the localized weather conditions will degrade the operation of the data center.

16. The system of claim 15, wherein, to schedule the first computational workload and the second computational workload, the data center management system is further configured to:
cause, using a machine learning model, the first computational workload to be executed during the period of time based on the first priority; and
cause, using the machine learning model, the second computational workload to be executed after the period of time based on the second priority.

17. The system of claim 16, wherein the data center is a first data center, and
wherein, to cause the first computational workload to be executed during the period of time, the data center management system is further configured to:
identify a second data center; and
causing the first computational workload to be executed during the period of time at the second data center,
wherein the first data center is a first cloud instance and the second data center is a second cloud instance.

18. The system of claim 16, wherein the data center management system is further configured to:
determine a third priority associated with a third computational workload of the plurality of computational workloads,
wherein the second priority exceeds the third priority; and
cause the third computational workload to be canceled during the period of time based on the third priority.

19. The system of claim 16, wherein, to cause the first computational workload to be executed during the period of time, the data center management system is further configured to:
determine one or more of a service level agreement associated with the first computation workload or a quality of service associated with the first computation workload; and
cause the first computational workload to be executed during the period of time based on the one or more of the service level agreement or the quality of service.

20. The system of claim 16, wherein the data center management system is further configured to:
provide weather information, regarding the localized weather conditions, to a building management system of the data center,
wherein the weather information is provided to the building management system to cause the building management system to control a data center temperature, of the data center, based on the weather information.
